(19) United States
(12) Patent Application Publication
(10) Pub. No.: US 2011/0092865 A1
(43) Pub. Date: Apr. 21, 2011

(54) MUSCLE TRAINING APPARATUS AND BELT FOR MUSCLE TRAINING

(75) Inventor: Yashiaki Sato, Tokyo (JP)

(73) Assignee: SATO SPORTS PLAZA CO., LTD., Tokyo (JP)

(21) Appl. No.: 12/674,851

(22) PCT Filed: Aug. 19, 2008
(86) PCT No.: PCT/JP2008/065064

§ 371 Date: Nov. 22, 2010

(30) Foreign Application Priority Data
Aug. 24, 2007 (JP) 2007219114

(51) Int. Cl. A61H 7/00

(52) U.S. Cl. 601/134

(57) ABSTRACT

To provide a belt for KAATSU muscle training of the type activated by using air pressure in which an inflatable pneumatic bag will expand only in an inward direction during use.

A belt 100B has a first band-shaped member 110 that is partially hollow in structure. The first band-shaped member 110 has a thick fabric 111 and a thin fabric 112 both of which are stretchable and are formed as a band shape, and contains an inflatable pneumatic bag 114 within the hollow portion. Small pieces 115, which are made of an unstretchable material and are fixed to strips of tape 116 of a predetermined width, are aligned along the radially outward extremity of the inflatable pneumatic bag 114. The strips of tape 116 are stitched to the thick fabric 111 and the thin fabric 112 at the ends thereof with the ends being sandwiched between the edges of the thick fabric 111 and the thin fabric 112.

### TECHNICAL FIELD

The present invention relates to a training apparatus for the muscle development. More particularly, the present invention relates to a KAATSU muscle training apparatus suitable for KAATSU muscle training that allows healthy people having no motor abnormalities as well as people having motor abnormalities to develop their muscles in an effective manner, and to a belt for such KAATSU muscle training.

### BACKGROUND OF THE INVENTION

Dr. Yoshiaki Sato, the present inventor, has conducted researches and investigations for a longtime in order to develop a muscle strength increasing method for easy, safe, and effective muscle development, and put together the accomplishments into a patent application having Japanese Patent Application No. 5-313949, which has been granted as Japanese Patent No. 2670421. In addition, the present inventor filed a U.S. patent application claiming priority of this application, which has been granted as U.S. Pat. No. 6,149,618.

In addition, the present inventor has gone over about the KAATSU muscle training on a daily basis, and invented some inventions for devices and apparatuses for use in implementing a KAATSU muscle training method, as disclosed in Japanese Patent Laid-Open Nos. 10-85361, 10-85362, 2004-215858, 2004-313423, 2005-509, and 2005-6921.

The muscle training method described in these applications is spreading fast in Japan because of its beneficial effects as described below. In addition, national and foreign physicians as well as universities have made researches and investigations about it and, as a result of them researchers including the present inventor have published many articles.

The muscle strength increasing method according to these patents is a distinctive non-conventional one that involves compression of an arm or leg at a position near the top thereof. This muscle strength increasing method (the subject muscle strength increasing method is herein referred to as a “KAATSU muscle training method”; the present applicant is active in promoting the KAATSU muscle training method under the name of a KAATSU training method, and the related trade names such as “KAATSU training”, “KAATSU TRAINING”, and “KAATSU” are trademarks claimed by the applicant of the present invention) is based on the following theoretical concept.

Muscles are composed of slow-twitch muscle fibers and fast-twitch muscle fibers. Slow-twitch muscle fibers are limited in their potential for growth. Accordingly, it is necessary to recruit fast-twitch muscle fibers of the slow- and fast-twitch muscle fibers in order to develop muscles. Recruitment of fast-twitch muscle fibers causes lactic acid buildup in the muscles, which triggers secretion of growth hormone from the pituitary. The growth hormone has effects of, for example, promoting muscle growth and shedding body fat. This means that recruitment and exhaustion of fast-twitch muscle fibers results in development of fast-twitch muscle fibers and, in turn, the entire muscles.

Slow-twitch muscle fibers and fast-twitch muscle fibers are different from each other in terms of the following. Slow-twitch muscle fibers use oxygen for energy and are recruited for low-intensity activities. Fast-twitch muscle fibers provide for activities regardless of whether or not oxygen is present. They are recruited after the slow-twitch muscle fibers for highly intense activities. Therefore, it is necessary to cause the earlier recruited and activated slow-twitch muscle fibers to be exhausted soon in order to recruit fast-twitch muscle fibers.

Conventional muscle strength increasing methods use heavy exercises with, for example, a barbell to cause the slow-twitch muscle fibers to be exhausted first, and then to recruit the fast-twitch muscle fibers. This recruitment of fast-twitch muscle fibers requires a significant amount of exercises, is time-consuming, and tends to increase the burden on muscles and joints.

On the other hand, muscle exercise may be performed under the restriction of muscle blood flow into the limb distal to a predetermined position by means of applying pressure upon the muscles at the predetermined position near the top of the limb. Since less oxygen is supplied to these muscles, the slow-twitch muscle fibers, which require oxygen for energy, are thus exhausted in a short period of time. Muscle exercises with blood-flow restriction by application of pressure will result in recruitment of the fast-twitch muscle fibers without needing a large amount of exercises. More specifically, when pressure is applied circumferentially upon a limb at a predetermined position near the top of the limb, venous circulation is restricted while arterial circulation is kept almost the same as the normal condition if an appropriate pressure is applied. This is because veins are closer to the skin surface of the limb, and are thinner and less muscular (less resistant against an force for pressurization) than arteries while arteries are found deep within the limb, and are thicker and more muscular than veins. By holding that condition for a certain period of time, the limb that has compressed near the top thereof becomes engorged with blood which runs from arteries but cannot flow through veins. This promotes a state of blood pooling in the capillaries where such an amount of blood is not flowing normally. The limb that is compressed at a position near the top thereof gets into a state as if it were doing heavy exercises. During this time, because of the temporal occlusion of the veins, the muscle fatigue is caused by the fact that the lactic acid that has built up in the muscles is less likely to be removed from the muscles. Furthermore, the brain receives information of strenuous exercise from muscles, and brain's physiological action is then responsible for the production of a much more growth hormone than is usually produced during the daily life for muscle regeneration as well as during typical exercises.

In other words, the KAATSU muscle training method contributes to artificially produce a state which otherwise will occur during and after heavy exercises. It is possible to cause muscle fatigue much more heavily than would be produced normally with that amount of exercises. In addition, the user can “trick” the brain into secreting a larger amount of growth hormone.

Because of the aforementioned mechanism, restriction of muscle blood flow can allow users to significantly develop their muscles.

The KAATSU muscle training method is premised on the theoretical concept of the muscle strength increase by the restriction of blood flow. More specifically, the KAATSU muscle training method involves the application of an appropriate force for pressurization to at least one of the limbs at a predetermined position near the top thereof to restrict the blood flow restriction into the limb distal to that position. The force for pressurization serves to put an appropriate stress attributed to blood flow decrease on the muscles. Thus, the muscles can be developed in an effective manner.

The KAATSU muscle training method features muscle development without any exercises because it involves developing muscles by putting a stress attributed to blood flow decrease on the muscles. With this feature, the KAATSU muscle training method is highly effective for the recovery of motor ability in people with impaired motor function, e.g., the elders or an injured person.

In addition, the KAATSU muscle training method can compensate for a total amount of stress that is placed on the muscles by putting on the muscles a stress attributed to blood flow decrease. When combined with some exercises, the method advantageously reduces an exercise-related load as compared with conventional methods. This feature produces effects of reducing possible risks of joint- or muscle-damages and shortening a necessary time period for training, because it can decrease the amount of muscle exercises for the muscle development.

It should be noted that, for the implementation of the KAATSU muscle training method, such a device or apparatus is essential that can restrict the blood flow through the muscles that are subject to be developed and that can precisely adjust the degree of blood flow restriction.

After researches and investigations about such devices and apparatuses, the present inventor invented the invention described in Japanese Patent Laid-open No. 10-085361.

A belt for the KAATSU muscle training according to the subject invention comprises a band-shaped member having a hollow tube-like shape, and an air-tight inflatable pneumatic bag housed in the band-shaped member. The inflatable pneumatic bag is adapted to be supplied with air from outside. The air can be released from the inflatable pneumatic bag to the outside. This belt is to be placed on a target compressed site near the proximal portion of an arm or leg of a user. With the belt placed on it, control can be made to supply air to the inflatable pneumatic bag and to remove the air from the inflatable pneumatic bag. By changing the air pressure within the inflatable pneumatic bag in the manner described above, an appropriate compression force can be applied to the target compressed site of the user.

However, such a belt still has a point that should be improved.

According to the researches and investigations made by the present inventor, it is better that the belt for the KAATSU muscle training is stretchable in the longitudinal direction over the entire length thereof. The KAATSU muscle training often involves some exercises although it can be effective even during the resting state. To perform the KAATSU muscle training, the belt is securely placed on the target compressed site near the proximal portion of an arm or leg. Exercises in this state can cause biting of the belt into the contracting bigger muscles, which results in a situation where an excessive compression force is applied by the belt to the target compressed site. Accordingly, it is preferable that the belt be moderately stretchable in order to avoid such a problem. The stretchable belt will stretch in conjunction with increasing girth of an arm or leg, avoiding the biting of the belt into the target compressed site. From such a viewpoint, the belt is often made of a stretchable material. However, a possible consequence is that, in the belt having the aforementioned inflatable pneumatic bag, the inflatable pneumatic bag supplied with air may be expanded in directions which are not necessarily towards the target compressed site. It is typical for the belt having the inflatable pneumatic bag to control the magnitude of the compression force to be applied to the target compressed site of the user based on the magnitude of the air pressure within the inflatable pneumatic bag. If the inflatable pneumatic bag expands in an outward direction of the belt (the term “outward” as used herein is intended to refer to the side away from the target compressed site when the belt is securely placed on the target compressed site), it becomes difficult to use the air pressure within the inflatable pneumatic bag to control the compression force to be applied to the target compressed site.

Taking this into consideration, the aforementioned patent application provides flat impeding pieces within the belt along the radially outward extremity of the inflatable pneumatic bag to confine the inflatable pneumatic bag to expand only in an inward direction (the term “inward” as used herein is intended to refer to the side closer to the target compressed site when the belt is securely placed on the target compressed site).

In addition, the present inventor invented a belt in which a lot of linear or rod-shaped members are provided along the radially outward extremity of the inflatable pneumatic bag at a predetermined distance in the longitudinal direction of the inflatable pneumatic bag to confine the inflatable pneumatic bag to expand only in an inward direction, and filed a patent application now published as Japanese Patent Laid-Open No. 2004-313423.

The approach using the flat impeding pieces and the one using the linear or rod-shaped members both have a certain effect of confining the inflatable pneumatic bag to expand only in an inward direction.

However, both of the approaches are not perfect to confine the inflatable pneumatic bag to expand only in a direction towards the target compressed site. The present inventor has recently found that the inflatable pneumatic bag is expanded in the direction other than towards the target compressed site and the direction is not only outward. The inflatable pneumatic bag is also expanded in a lateral direction corresponding to the widthwise direction of the belt.

The approach using the flat impeding pieces and the one using the linear or rod-shaped members both do not expect to be able to prevent the lateral expansion of the inflatable pneumatic bag. Therefore, it is impossible to prevent such lateral expansion of the inflatable pneumatic bag.

The present invention is directed to improve a belt having an inflatable pneumatic bag for the KAATSU muscle training so that the outward and lateral expansion of the inflatable pneumatic bag can be prevented effectively during the use of the belt.

### SUMMARY OF THE INVENTION

In order to solve the aforementioned problems, the present inventor proposes a belt for KAATSU muscle training as described below (hereinafter, sometimes merely referred to as a “belt”).

The present invention is a belt for KAATSU muscle training for the development of muscles that is used for applying a predetermined force for pressurization to a target compressed site near the proximal portion of one of the limbs of a user so that blood flow through the limb is restricted. Then, this belt comprises a stretchable band-shaped member, at least a part of the band-shaped member having a tube-like shape, the band-shaped member having a length that is enough to be wound around the target compressed site almost one complete turn or more; fastening means with which the shape of said band-shaped member can be maintained while said band-shaped member is wrapped around the target compressed site; an inflatable pneumatic bag that is disposed within the tube-like portion of said band-shaped member, the inflatable pneumatic bag having a length that is enough to be wound around the target compressed site almost one complete turn or more, the inflatable pneumatic bag being air tight and being adapted to supply gas from the outside to the inside thereof and to remove the gas within it from the outside; a plurality of plate-shaped small pieces that are aligned along the radially outward extremity of said inflatable pneumatic bag; and strips of tape each having a predetermined width, the strip of tape being fixed to the outer surface of said small piece at the midpoint along the longitudinal center line thereof that is in parallel with the direction of the width of said band-shaped member, the opposite ends of each strip of tape being fixed to the opposite edges of said band-shaped member, the opposite edges corresponding to the opposite ends thereof in a lateral direction, the strip of tape being made of an unstretchable material.

This belt comprises a plurality of plate-shaped small pieces that are aligned along the radially outward extremity of the inflatable pneumatic bag; and strips of tape each having a predetermined width, the strip of tape being fixed to the outer surface of the small piece at the midpoint along the longitudinal center line thereof that is in parallel with the direction of the width of the band-shaped member, the opposite ends of each strip of tape being fixed to the opposite edges of the band-shaped member, the opposite edges corresponding to the opposite ends thereof in a lateral direction, the strip of tape being made of an unstretchable material.

In the belt according to the present application, the aforementioned small pieces contribute to prevent the outward expansion of the inflatable pneumatic bag which otherwise occurs when the inflatable pneumatic bag is supplied with air.

In addition, the aforementioned strips of tape prevent the small pieces themselves from moving outward. This results in much better prevention of the outward expansion of the inflatable pneumatic bag which otherwise occurs when the inflatable pneumatic bag is supplied with air. Furthermore, the strips of tape prevent the lateral expansion of the inflatable pneumatic bag. This is based on a finding that the present inventor has found in the course of his researches about the behavior of the expanding inflatable pneumatic bag within the belt, that is, when the inflatable pneumatic bag expands in a lateral direction, the stretchable band-shaped member is pushed by the inflatable pneumatic bag and stretches in the lateral direction, so that preventing the lateral stretch of the band-shaped member results in prevention of the lateral expansion of the inflatable pneumatic bag. The multiple strips of tape in the present invention have two functions of preventing the lateral expansion of the inflatable pneumatic bag and preventing the outward expansion of the inflatable pneumatic bag. These functions serve to achieve the inward expansion of the inflatable pneumatic bag.

In addition, the aforementioned strips of tape contribute to achieving the inward expansion of the inflatable pneumatic bag, but they cannot prevent lengthwise stretch of the belt. The strips of tape are provided within the band-shaped member at a predetermined distance. The portions of the band-shaped member that are located at positions corresponding to the adjacent strips of tape can stretch in the longitudinal direction of the band-shaped member. Thus, in the belt according to the present invention, it is possible to avoid the situation where the compression force to be applied by the belt to the target compressed site becomes excessively large even when the user performs exercises with the belt being placed on the target compressed site.

The small pieces in the present invention are aligned along the radially outward extremity of the inflatable pneumatic bag. Each small piece may or may not have the same shape. Each small piece may be made of any material as long as it can ensure sufficient stiffness to prevent the outward expansion of the inflatable pneumatic bag. For example, the small pieces are made of a resin. The distance between the adjacent small pieces may or may not be the same.

Said small pieces may be positioned so that the adjacent small pieces are spaced apart from each other by 10 mm or less during the time when said belt is not under tension. Preferably, this distance is 5 mm or less. The adjacent small pieces may be abutted to or slightly overlapped with each other during the time when the belt is not under tension. The small pieces, if slightly overlapped with each other, do not badly affect the flexibility of the belt that is required for wrapping the belt around the target compressed site. On the other hand, it is preferable that the adjacent small piece be away from each other at a distance of 10 mm or less during the time when said belt is under appropriate tension. This may be determined based on the distance between the small pieces as measured during the time when the belt is not under tension as well as the stretchability of the belt that is obtained when the belt is under tension. If the distance between the adjacent small pieces are too large during the time when the belt is under tension (i.e., when it is used), the function of the small pieces to confine the inflatable pneumatic bag to expand only inwardly may become insufficient. Taking this into consideration, it is preferable that the distance between the small pieces be equal to or smaller than 10 mm during the time when the belt is under tension.

The strips of tape in the present invention are made of an unstretchable material as described above. The term “unstretchable” as used herein is meant to represent substantially unstretchable. The strips of tape may be made of an appropriate material such as fabric or a sheet of resin. The strips of tape are fixed to the respective small pieces, and thus the number of the strips of tape required is equal to the number of the small pieces. All strips of tape may or may not be the same. The widths of the strips of tape may or may not be identical for all portions or parts in the longitudinal direction thereof. The strips of tape may or may not be aligned in parallel to each other. The distances between the adjacent strips of tape may or may not all be the same.

The width of the portion at the opposite ends of said strip of tape that are fixed to the opposite edges of said band-shaped member may be shorter than the length of said small piece in the longitudinal direction of said band-shaped member (in this case, the length of the small pieces represents the maximum length thereof in the longitudinal direction of the band-shaped member). It is not preferable that the length of the small pieces in the longitudinal direction of the band-shaped member be too short in view of preventing the outward expansion of the band-shaped member. By the way, the stretchability of the belt in the present invention can be kept as described above, but the opposite ends of the strip of tape that are fixed to the opposite edges of the band-shaped member interfere with the stretchability of the belt. Accordingly, if the width of the opposite ends of the strip of tape is as large as the length of the small piece in the longitudinal direction of the band-shaped member, the stretchability of the belt may be affected. On the other hand, by using the width of the opposite ends of the strip of tape that is smaller than the length of the small piece in the longitudinal direction of the band-shaped member, it is possible to balance the prevention of the outer expansion of the band-shaped member by the small pieces and the stretchability of the belt.

For example, when said small piece has a rectangular shape and when one of two pairs of opposite sides of said small piece is in parallel with the lengthwise direction of said belt, all strips of tape can have a constant width and the width of the strip of tape can be smaller than the length of the small piece in the longitudinal direction of the band-shaped member.

How to fix the strips of tape to the band-shaped member is not specifically limited as long as the opposite ends of each strip of tape are fixed to the opposite edges of the band-shaped member. How to fix the strips of tape to the band-shaped member may depend on, for example, the structure of the band-shaped member.

For example, the tube-like portion of said band-shaped member comprises apiece of elongated outer fabric that is provided outside and a piece of elongated inner surface that is provided inside, and the opposite edges corresponding to the opposite ends of the outer fabric and the inner fabric in a widthwise direction may sometimes be connected to each other. In such a case, said strip of tape may be fixed to said band-shaped member at the opposite ends thereof with the opposite ends being sandwiched between said opposite edges of said outer fabric and the inner fabric. In such a case, the outer fabric, the inner fabric, and the tapes may be attached to each other by means of bonding with adhesive or by using welding or fusion. This allows easy fixing of the tape to the band-shaped member.

The tube-like portion of said band-shaped member comprises a piece of elongated outer fabric that is provided outside and a piece of elongated inner surface that is provided inside, and the opposite edges corresponding to the opposite ends of the outer fabric and the inner fabric in a widthwise direction may sometimes be stitched to each other. In such a case, said strip of tape may be fixed to said band-shaped member at the opposite ends thereof with the opposite ends being stitched together with said opposite edges of said outer fabric and the inner fabric. This allows easy fixing of the tape to the band-shaped member.

The inflatable pneumatic bag according to the present invention may be stretchable in the longitudinal direction thereof. As apparent from the above, even when the band-shaped member is stretchable in the longitudinal direction thereof, the inflatable pneumatic bag has the potential for preventing stretch of the band-shaped member if the inflatable pneumatic bag is not stretchable in the longitudinal direction thereof. In order to avoid this, the inflatable pneumatic bag may be rendered stretchable in the longitudinal direction.

The length of the inflatable pneumatic bag according to the present invention is equal to or longer than the length that is enough to be wound around the target compressed site almost one complete turn. This is for the purpose of allowing for evenly compressing the target compressed site from all directions. Although the length of the inflatable pneumatic bag is equal to or longer than the length that is enough to be wound around the target compressed site one complete turn, the circumference of the target compressed site varies among different individuals. Besides, even for the same person, it varies over time longer than a certain period due to some factors including past training. Accordingly, it is preferable that the length of the inflatable pneumatic bag be slightly longer than the circumference of the target compressed site of a person who is expected to use that belt by, for example, approximately 10% to 50%.

By utilizing the belt for the KAATSU muscle training as described above, it is possible to implement a KAATSU muscle training apparatus as described below.

The KAATSU muscle training apparatus comprises at least one belt for KAATSU muscle training for the development of muscles that is used for applying a predetermined force for pressurization to a target compressed site near the proximal portion of at least one of the limbs of a user so that blood flow through the limb is restricted; and a main device having a pump, the main device being used in combination with said belt. Then, said belt in this KAATSU muscle training apparatus comprises a stretchable band-shaped member, at least a part of the band-shaped member having a tube-like shape, the band-shaped member having a length that is enough to be wound around the target compressed site almost one complete turn or more; fastening means with which the shape of said band-shaped member can be maintained while said band-shaped member is wrapped around the target compressed site; an inflatable pneumatic bag that is disposed within the tube-like portion of said band-shaped member, the inflatable pneumatic bag having a length that is enough to be wound around the target compressed site almost one complete turn or more, the inflatable pneumatic bag being air tight and being adapted to supply gas from the outside to the inside thereof and to remove the gas within it from the outside; a plurality of plate-shaped small pieces that are aligned along the radially outward extremity of said inflatable pneumatic bag; and strips of tape each having a predetermined width, the strip of tape being fixed to the outer surface of said small piece at the midpoint along the longitudinal center line thereof that is in parallel with the direction of the width of said band-shaped member, the opposite ends of each strip of tape being fixed to the opposite edges of said band-shaped member, the opposite edges corresponding to the opposite ends thereof in a lateral direction, the strip of tape being made of an unstretchable material. Said main device is adapted to supply air into said inflatable pneumatic bag or to remove air from said inflatable pneumatic bag by using the pump that it has.

### BRIEF DESCRIPTION OF THE DRAWINGS

FIG. 1 is a view schematically showing the entire configuration of a KAATSU muscle training apparatus of a first embodiment of the present invention;

FIG. 2 is a perspective view showing a belt included in the KAATSU muscle training apparatus in FIG. 1;

FIG. 3 is a cross-sectional view showing the belt included in the KAATSU muscle training apparatus in FIG. 1;

FIG. 4 is a plane perspective view showing the belt included in the KAATSU muscle training apparatus in FIG. 1;

FIG. 5 is a view schematically showing an internal configuration of the main device included in the KAATSU muscle training apparatus in FIG. 1;

FIG. 6 is a hardware configuration of the control segment included in the KAATSU muscle training apparatus in FIG. 1;

FIG. 7 is a view showing a functional block generated in the control segment included in the KAATSU muscle training apparatus in FIG. 1;

FIG. 8 is a plane cross-sectional view illustrating how the belt included in the KAATSU muscle training apparatus in FIG. 1 is placed on the right leg of a user;

FIG. 9 is a plane cross-sectional view illustrating how the belt included in the KAATSU muscle training apparatus in FIG. 1 is placed on the right arm of a user;

FIG. 10 is a cross-sectional view and a plane perspective view showing a configuration of a belt for KAATSU muscle training according to a second embodiment; and

FIG. 11 is a view illustrating how a belt for KAATSU muscle training according to a second embodiment is placed on a target compressed site.

### BEST MODES FOR CARRYING OUT THE INVENTION

Preferred first and second embodiments of the present invention are described now with reference to the drawing. In the description of both embodiments, similar components and parts are depicted by the like reference numerals, and any redundant description will be omitted.

### First Embodiment

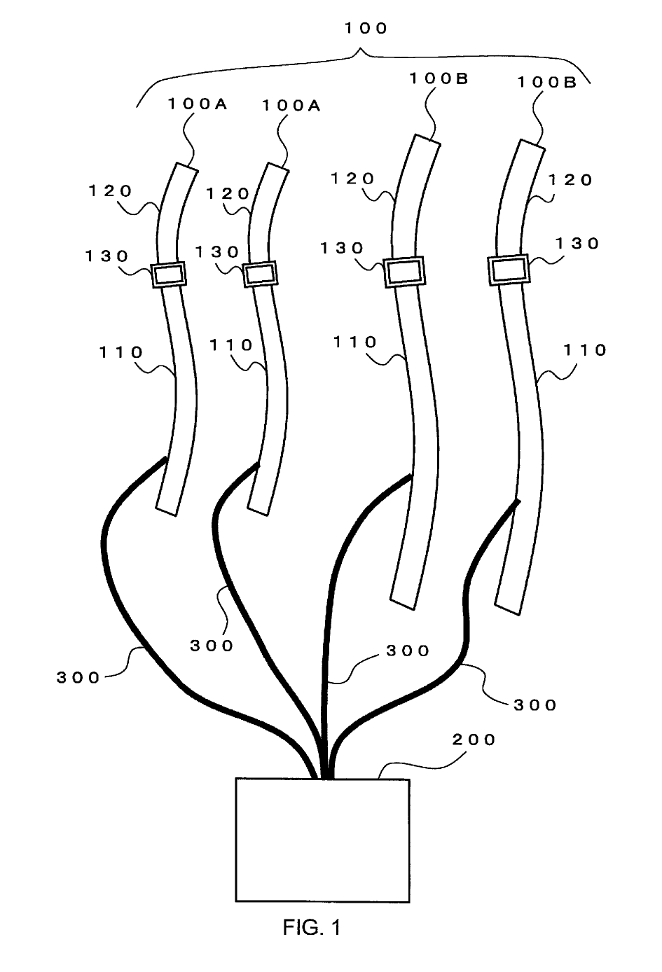

FIG. 1 is a view schematically showing the entire configuration of a KAATSU muscle training apparatus according to a first embodiment of the present invention.

As shown in FIG. 1, the KAATSU muscle training apparatus according to this embodiment comprises a belt 100 and a main device 200. Each component of the belt 100 is designed so that it can be connected to the main device 200 through, for example, a connecting pipe 300 comprised of a rubber tube.

The belt 100 in this embodiment comprises a plurality of, more specifically, four components as shown in FIG. 1. The reason why there are four components of the belt 100 is to allow secure placement of the components of the belt 100 on the arms and legs, respectively, of a person (user) who uses the KAATSU muscle training method. The components of the belt 100 are tightened around a predetermined range (target compressed site) near the proximal portion of the arms and legs of the user.

Of the four components of the belt 100, belts 100A are for arms (each of which is intended to be wrapped around an arm for the compression of the target compressed site on the arm) while belts 100B are for legs (each of which is intended to be wrapped around a leg for the compression of the target compressed site on the leg). The number of the components of the belt 100 is not necessarily four. Any number equal to or larger than one may be used. The number of the belt(s) 100A for arms is not necessarily identical with the number of the belt(s) 100B for legs. More than four components of the belt 100 may be provided to cope with cases where two or more persons perform the KAATSU muscle training at the same time.

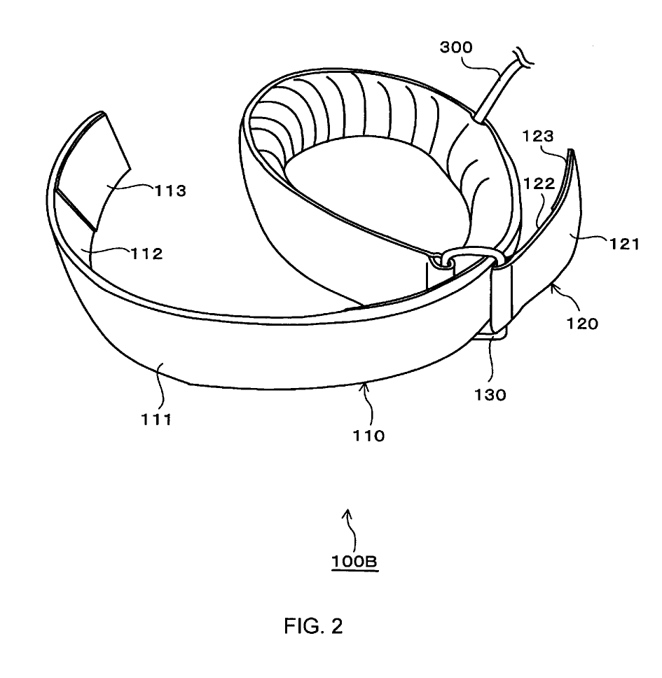

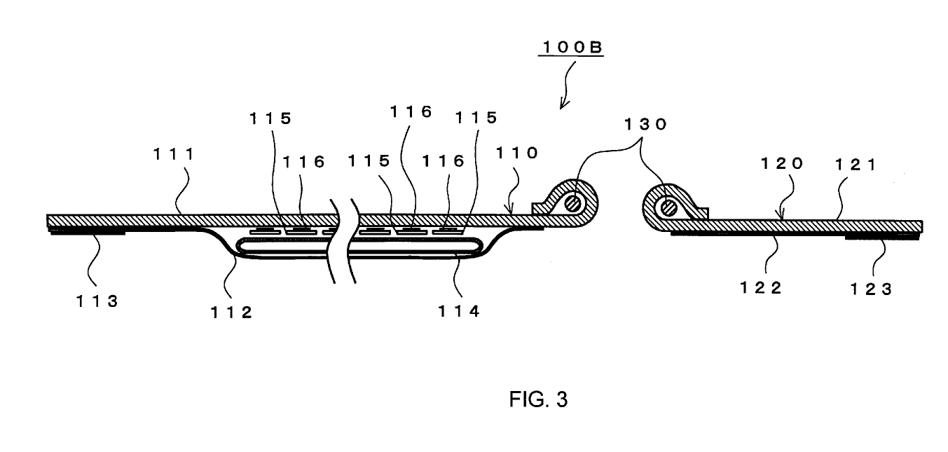

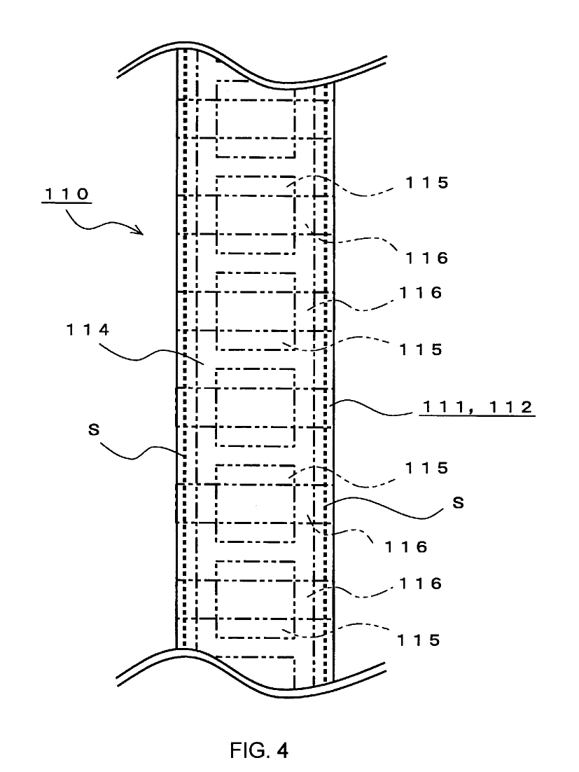

The belt 100 in this embodiment is structured as shown in FIGS. 1, 2, 3, and 4. FIG. 2 is a perspective view showing an embodiment of the belt 110B for legs. FIG. 3 is a cross-sectional view in longitudinal direction of the belt 100B. FIG. 4 is a plane perspective view showing a structure of a first band-shaped member described below having an inflatable pneumatic bag described below of the belt 100B.

The belt 100 in this embodiment is intended to be wrapped around a target compressed site of a limb. It is intended to apply a predetermined compression force to the target compressed site, and is adapted so that the compression force to be applied to a predetermined range of the arm or the leg can be varied in a manner described below.

Regardless of whether it is for use in arms or legs, each component of the belt 100 comprises a first band-shaped member 110 and a second band-shaped member 120 both of which have an elongated shape, and a joint member 130.

The joint member 130 is connected to the proximal end (the end closer to the joint member 130) of the first band-shaped member 110 and the proximal end (the end closer to the joint member 130) of the second band-shaped member 120. The joint member 130 has an opening through which the first band-shaped member 110 can be passed. It has a rectangular ring shape in this embodiment, but is not necessarily so. The first band-shaped member 110 and the second band-shaped member 120 are attached to the opposing sides, respectively, of the joint member 130.

The total length of the belt 100, i.e., the combined length of the first band-shaped member 110, the second band-shaped member 120, and the joint member 130, may be determined in accordance with the girth of the target compressed site of a person who uses the KAATSU muscle training method. The total length of the belt 100 should be at least longer than the length of the girth of the target compressed site of the user. The total length of the belt 100 in this embodiment is approximately twice as long as the girth of the target compressed site of the user (the length is twice ±20% as long as the expected length of the girth of the target compressed site). In order to meet requirements for all expected users, the belts 100A and the belts 100B of different total lengths are provided.

The total length of the belt 100A for arms according to this embodiment is determined in view of the girth of the target compressed site on the arm of the user being 26 cm. More specifically it is approximately 50 cm. The total length of the belt 100B for legs is determined in view of the girth of the target compressed site on the leg of the user being 45 cm. More specifically, it is approximately 80 cm.

The first band-shaped member 110 is longer than the second band-shaped member 120. The first band-shaped member 110 should have a length that is enough to be wound around the target compressed site of the user one complete turn or more. The length of the first band-shaped member 110 of the belt 100A for arms according to this embodiment is approximately 40 cm in view of the girth of the target compressed site on the arm of the user being 26 cm, which is not necessarily so. On the other hand, the length of the second band-shaped member 120 of the belt 100A for arms is approximately 10 cm. The length of the first band-shaped member 110 of the belt 100B for legs according to this embodiment is approximately 65 cm in view of the girth of the target compressed site on the leg of the user being 45 cm, which is not necessarily so. On the other hand, the length of the second band-shaped member 120 of the belt 100B for legs is approximately 15 cm. It is noted that the only requirement for the length of the second band-shaped member 120 is that it is not inconvenient for a person to grasp it, irrespective of the belt 100A for arms and the belt 100B for legs. The lengths of the first and second band-shaped members 110 and 120 are determined in consideration with this requirement, plus the requirement for the first band-shaped member 110 that it should be longer than the girth of the target compressed site plus the requirement that the total length of the belt 100 is approximately twice as long as the length of the girth of the target compressed site of the user.

In this embodiment, the first band-shaped member 110 has a constant width along the entire length thereof for both of the belt 100A for arms and the belt 100B for legs, which is not necessarily so. The same applies to the second band-shaped member 120. In addition, in this embodiment, the width of the first band-shaped member 110 is identical to the width of the second band-shaped member 120 for both of the belt 100A for arms and the belt 100B for legs, which is not necessarily so. The widths of the first band-shaped member 110 and the second band-shaped member 120 may appropriately be determined in view of whether the target compressed site is on an arm or on a leg. For example, for the belt 100A for arms, the widths of the first band-shaped member 110 and the second band-shaped member 120 may be approximately 3 cm to 3.5 cm. For the belt 100B for legs, the widths of the first band-shaped member 110 and the second band-shaped member 120 may be approximately 5 cm to 5.5 cm.

The first band-shaped member 110 has the outer surface that is made of a thick fabric 111 and the inner surface that is made of a thin fabric 112.

The thick fabric 111 of the first band-shaped member 110 is connected to the joint member 130 at the proximal end thereof. The connection between the first band-shaped member 110 and the joint member 130 may be achieved in any way. For example, as shown in FIG. 3, the proximal end of the thick fabric 111 may be passed through the opening in the joint member 130, folded back on itself and stitched to the overlapping surface of the thick fabric 111. The connection between the second band-shaped member 120 and the joint member 130 is also achieved as in the case of the connection between the first band-shaped member 110 and the joint member 130.

The thick fabric 111 in this embodiment is a piece of fabric having a width of approximately 3 mm and is resilient to a certain extent. The thick fabric 111 is stretchable in its longitudinal direction. The thin fabric 112 in this embodiment is a piece of fabric having a width of 0.5 mm. The thin fabric 112 is made of a soft material that is comfortable to the touch by the user because it will be in contact with the target compressed site of the user when the belt 100 is securely placed on the target compressed site of the user. The thin fabric 112 is also stretchable in its longitudinal direction. Since the thick fabric 111 and the thin fabric 112 are both stretchable, the first band-shaped member 110 is stretchable in its longitudinal direction.

The outer surface of the thick fabric 111 is a surface that can be removably engaged with a second hook-and-loop fastener and a third hook-and-loop fastener described below. It virtually functions as a hook-and-loop fastener (first hook-and-loop fastener). The inner surface of the thick fabric 111 at the distal end thereof (the end that is away from the joint member 130) is provided with a second hook-and-loop fastener 113 having a length of 4 to 5 cm, which is not necessarily so. The second hook-and-loop fastener 113 is made of a Velcro tape.

The thick fabric 111 and the thin fabric 112 are connected to each other along their longitudinal edges corresponding to their opposite sides perpendicular to the lateral direction, by means of stitching in this embodiment. The thick fabric 111 and the thin fabric 112 are stitched together along the dotted line S shown in FIG. 4. The thick fabric 111 and the thin fabric 112 are connected to each other only along their edges in a predetermined distance from the joint member 130. Accordingly, the portion of the first band-shaped member 110 extending from the joint member 130 to that point is a tube-like object. An inflatable pneumatic bag 114 is provided within the tube-like first band-shaped member 110.

The inflatable pneumatic bag 114 is an elongated air-tight bag that is stretchable at least in its longitudinal direction. The inflatable pneumatic bag 114 is made of, but not limited to, a raw rubber in this embodiment. As shown in FIG. 2, the inflatable pneumatic bag 114 is connected to one end of the connecting pipe 300. The aforementioned stitching between the thick fabric 111 and the thin fabric 112 along their longitudinal edges is not made at the position through which the connecting pipe 300 is passed so that the connecting pipe 300 can be introduced into the first band-shaped member 110. The inflatable pneumatic bag 114 is supplied with air from the main device 200 through the connecting pipe 300. The air within the inflatable pneumatic bag 114 is removed by the main device 200. Such delivery and release of air into and from the inflatable pneumatic bag 114 is performed by the main device 200.

The length of the inflatable pneumatic bag 114 is such that it can wrap around the target compressed site at least one turn. The length of the inflatable pneumatic bag 114 in the belt 100A for arms according to this embodiment is approximately 35 cm in view of the girth of the target compressed site on the arm of the user being 26 cm. The length of the inflatable pneumatic bag 114 in the belt 100B for legs according to this embodiment is approximately 55 cm in view of the girth of the target compressed site on the arm of the user being 45 cm. The length of the inflatable pneumatic bag 114 may be determined so that it is approximately 10% to 50% longer than the girth of the target compressed site.

In the outside of the inflatable pneumatic bag 114, small pieces 115 and strips of tape 116 are provided, as shown in FIGS. 3 and 4.

Each of the small pieces 115 is, as described below, a plate-like member for use in confining the inflatable pneumatic bag 114 to expand only in an inward direction when inflated with supplied air. The small pieces 115 are made of a material that is stiff enough to achieve this function. The small pieces 115 are made of, but not limited to, a resin in this embodiment.

There are many small pieces 115 and each of them has the same shape in this embodiment but is not necessarily so. In addition, the shape is, but not limited to, a rectangle. The small pieces 115 are, but not limited to, equally and slightly spaced apart from each other in this embodiment. The small piece 115 has a lateral dimension (along the width of the belt 100) that is 60 to 100% as long as the width of the inflatable pneumatic bag 114 from a planar perspective, and has a longitudinal dimension (along the length of the belt 100) that is approximately equal to the lateral dimension thereof. However, the dimensions of the small pieces 115 are not limited to the above.

Each of the strips of tape 116 is a band-shaped member extending in the lateral direction of the first band-shaped member 110. The strips of tape 116 are fixed to the respective small pieces 115 in a manner described below. Thus, the number of the strips of tape 116 is equal to the number of the small pieces 115. All strips of tape 116 are identical in this embodiment, but are not necessarily so.

The strips of tape 116 are made of an unstretchable material. The strips of tape 116 may be made of fabric, but are made of a flexible and unstretchable resin film material in this embodiment. The width of each strip of tape 116 is, but not limited to, equal in all positions along the length in this embodiment. The length of each strip of tape 116 is, but not limited to, equal to the width of the first band-shaped member 110 in this embodiment. The width of each strip of tape 116 is shorter than the longitudinal length of the small piece 115. The width of the strips of tape 116 may be as small as possible without any inconvenience to stitch the strips of tape 116 to the thick fabric 111 and the thin fabric 112 as described below. However, in this embodiment, the width is within 20 to 70% of the longitudinal length of the small pieces 115, which is not necessarily so.

The strip of tape 116 is fixed to the small piece 115 at the midpoint along the longitudinal center line thereof. The strips of tape 116 are placed on the outer surface of the respective small pieces 115. The fixing between the strips of tape 116 and the small pieces 115 may be achieved in any manner. For example, they are bonded to each other with adhesive. In this embodiment, they are fixed together by stitching. More specifically, the strip of tape 116 and the small piece 115 are stitched together along the lateral center line of the strip of tape 116.

The opposite ends of the strip of tape 116 are both fixed to the opposite edges of the first band-shaped member 110 by means of stitching the ends to the edges of the thick fabric 111 and the thin fabric 112. In order to produce the first band-shaped member 110, the thick fabric 111, the strips of tape 116 to which the respective small pieces 115 are fixed, and the thin fabric 112 are stacked on top of each other and stitched together along the aforementioned dotted line S.

With this structure, the small pieces 115 are aligned on top of the inflatable pneumatic bag 114. The strips of tape 116 are aligned on top of the small pieces 115. In this embodiment, the strips of tape 116 are all aligned in parallel and the gap between the adjacent small pieces 115 is equal to or shorter than 10 mm, and preferably, equal to or shorter than 5 mm as measured on the belt 100 that is not tensioned. This gap is 3 to 4 mm in this embodiment. However, there may be no gap between the adjacent small pieces 115. The adjacent small pieces 115 may slightly (e.g., approximately 1 mm) be overlapped to each other at the end thereof. The gap between the adjacent small pieces 115 is equal to or shorter than 10 mm, and preferably, equal to or shorter than 5 mm as measured on the belt 100 that is tensioned.

The second band-shaped member 120 is, briefly speaking, identical in structure to the first band-shaped member 110 except that there is no inflatable pneumatic bag 114.

The second band-shaped member 120 has the outer surface that is made of a thick fabric 121 and the inner surface that is made of a thin fabric 122. The thick fabric 121 and the thin fabric 122 of the second band-shaped member 120 are made of a material similar to the one used for the thick fabric 111 and the thin fabric 112, respectively, of the first band-shaped member.

The thick fabric 121 and the thin fabric 122 are connected to each other by means of stitching in this embodiment.

The outer surface of the thick fabric 121 is a surface that can be removably engaged with the second hook-and-loop fastener 113. It virtually functions as a hook-and-loop fastener (fourth hook-and-loop fastener). The inner surface of the thick fabric 121 at the distal end thereof (the end that is away from the joint member 130) is provided with a third hook-and-loop fastener 123 having a length of 4 to 5 cm, which is not necessarily so. The third hook-and-loop fastener 123 is made of a Velcro tape.

Next, a configuration of the main device 200 is described.

The main device 200 is capable of supplying gas into the inflatable pneumatic bag 114 and removing the gas from the inflatable pneumatic bag 114. The control that is carried out by the main device 200 for supplying and removing the gas into and from the inflatable pneumatic bag 114 is achieved automatically in this embodiment, which is not necessarily so. The main device 200 may have any configuration as long as it can supply the gas into the inflatable pneumatic bag 114 and removes the gas from the inflatable pneumatic bag 114, and as long as it can achieve the aforementioned automatic control. The main device 200 may be those disclosed in, for example, Japanese Patent Laid-Open Nos. 2007-125254, 2005-58544, and 2005-6921.

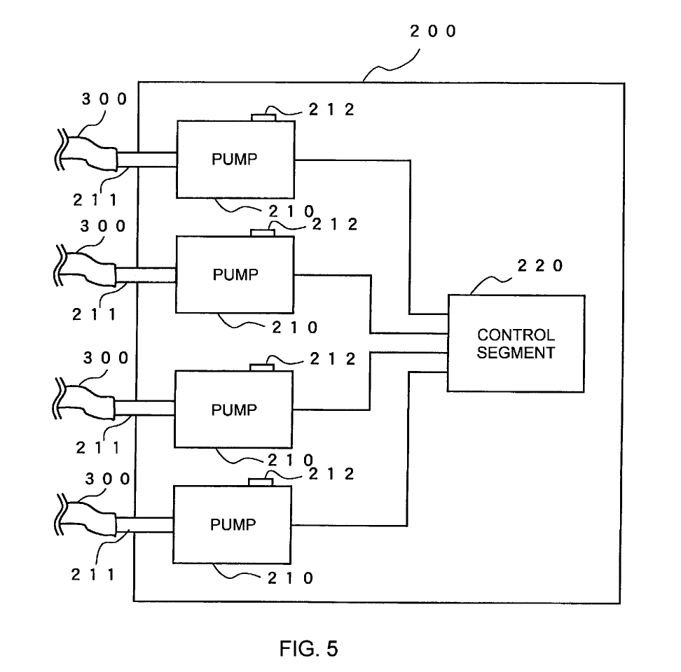

A configuration of an exemplary main device 200 is schematically shown in FIG. 5. As shown in FIG. 5, the main device 200 is composed of four pumps 210 and a control segment 220. In this embodiment, the main device 200 comprises a casing in which the pumps 210 and the control segment 220 are housed. An input device is provided outside the casing but is not illustrated herein.

Each of the four pumps 210 is associated with one of the four components of the belt 100.

The pump 210 has a function of sucking the surrounding air and supplying it to the outside through a pump connection port 211 which will be described below. The pump 210 includes a valve 212. By opening the valve 212, the gas in the pump 210 can be discharged to the outside. Each of the four pumps 210 has its own pump connection port 211 and is connected to the inflatable pneumatic bag 114 through the connecting pipe 300 connected thereto. When the pump 210 forces the gas, the gas is introduced into the inflatable pneumatic bag 114. When the pump 210 opens the valve 212, the gas can be removed from the inflatable pneumatic bag 114. The valve 212 is not necessarily provided in the pump 210. It may be disposed at any point along the path from the pump 210 to the inflatable pneumatic bag 114.

The pump 210 contains a pressure gauge which is not shown in order to measure the air pressure within the pump 210. The air pressure within the pump 210 is obviously equal to the air pressure within the inflatable pneumatic bag 114.

The control segment 220 is for controlling the pumps 210. The control segment 220 performs control to activate the pump 210 in order to introduce the air into the inflatable pneumatic bag 114 in the belt 100 while the valve 212 is closed, and to open the valve 212 in the pump 210 to remove the air from the inflatable pneumatic bag 114. In other words, the control segment 220 controls the pump 210 in addition to the opening and closing of the valve 212.

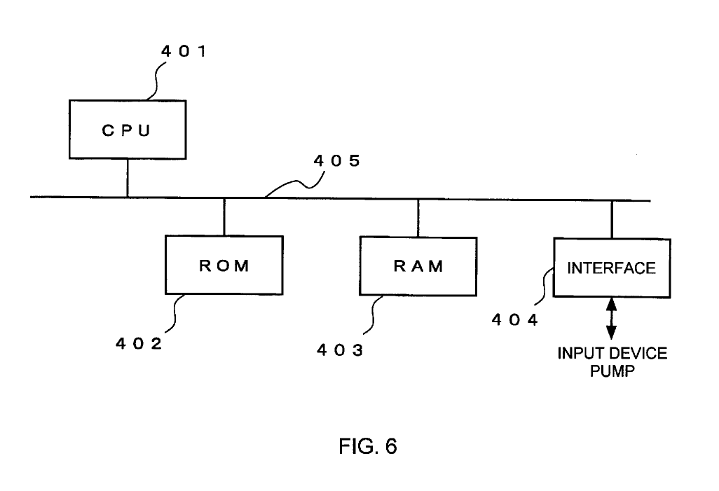

An internal configuration of the control segment 220 is schematically shown in FIG. 6. The control segment 220 contains a computer wherein a CPU 401, an ROM 402, an RAM 403 and an interface 404 are connected to each other through a bus 405.

The CPU 401 is a central processing unit that controls the whole control segment 220. The ROM 402 records a program and data that are necessary for the processing described below in which the processing is carried out by the control segment 220. The CPU 401 executes the processing based on the program. The ROM 402 may be embodied by using a flash ROM. Instead of the ROM 402, or in addition to the ROM 402, the control segment 220 may comprise other recording medium such as a hard disk on which the aforementioned program and the data are recorded. The RAM 403 is for providing a working area for the execution of the aforementioned program. The interface 404 has functions of receiving an input from the input device and sending an instruction from the control segment 220 to each of the four pumps 210.

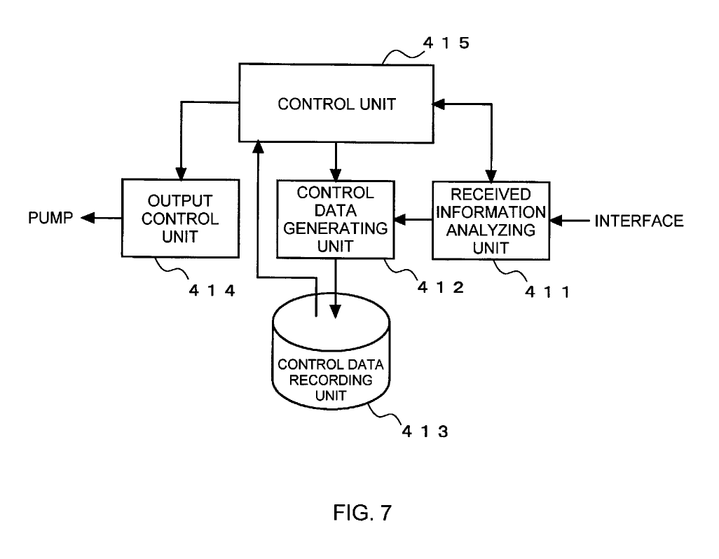

As the CPU 401 executes the aforementioned program, a functional block as shown in FIG. 7 is created within the control segment 220.

The control segment 220 includes a received information analyzing unit 411, a control data generating unit 412, a control data recording unit 413, an output control unit 414, and a control unit 415.

The received information analyzing unit 411 receives an input supplied from the input device, via the interface 404 and analyzes the details thereof. Data representing the result of the analysis by the received information analyzing unit 411 are supplied to the control data generating unit 412 or the control unit 415.

The control data generating unit 412 is for generating control data for use in controlling the pump 210 including the opening and closing of the valve 212, according to the data received from the received information analyzing unit 411. The control data generating unit 412 is adapted to record the generated control data on the control data recording unit 413.

The control data recording unit 413 is for recording the control data received from the control data generating unit 412. On the control data recording unit 413 in this embodiment, the control data associated with the respective one of the four pumps 210 are recorded as a set. In addition, the control data recording unit 413 in this embodiment is adapted to record two or more sets of the control data for the four pumps 210. A single set of the data is for controlling compression of the arms and the legs during the KAATSU muscle training. The two or more sets of the data may be those for two or more persons. In such a case, the data is read for a user who receives the KAATSU muscle training depending on who receives the KAATSU muscle training. In addition, the two or more sets of the data may be those for one specific person who receives the KAATSU muscle training. In such a case, the person may use different data that are read depending on, for example, physical conditions. The number of the sets of the data may be equal to the number of the persons and each set may include different data.

The control unit 415 is for totally controlling the received information analyzing unit 411, the control data generating unit 412, and the output control unit 414. In addition, it has a function of controlling the modes described below. The control unit 415 has functions of reading a set of control data from the control data recording unit 413 and sending them to the output control unit 414 when the KAATSU muscle training is performed.

The output control unit 414 has a function of controlling the pump 210 according to the control data. The KAATSU muscle training is performed while the output control unit 414 is controlling the pump 210.

Next, how the KAATSU muscle training is performed by using this main device 200 is described.

First, the control data is generated.

The main device 200 of the present invention is adapted to carry out two modes: a control mode and a training mode. The control data is generated in the control mode.

An input about which one of the control mode and the training mode is to be selected is made by using the input device. When information indicating which one of the control mode and the training mode is to be selected is supplied from the input device, the received information analyzing unit 411 which receives the information through the interface 404 transfers it to the control unit 415. In response to this, the control unit 415 begins to use the control mode or the training mode.

In this main device 200, it is possible to enter the information that is necessary for the generation of the control data, by means of manipulating the input device during the time when the control mode is active. The entered information is transmitted to the control data generating unit 412 through the interface 404 and the received information analyzing unit 411. The control data generating unit 412 generates the control data according to the received information, and transmits it to the control data recording unit 413. The control data recording unit 413 records that data. As described above, as to the control data in this embodiment, four data corresponding to the respective four pumps 210 are combined as a single set. The control data is the one that indicates in what way the air pressure in the pump 210 should be changed over time.

In this embodiment, two or more sets each having four control data are recorded on the control data recording unit 413, so that the aforementioned processing is repeated as many times as necessary. Thus, in this embodiment, the control data suitable for different individuals who receive the KAATSU muscle training are generated in a so-called custom-made manner.

It is noted that typical or general-purpose control data may be recorded on the control data recording unit 413 before shipping the main device 200. The number of the control data to be recorded on the control data recording unit 413 may be equal to or larger than one.

After the control data is generated, the main device 200 is connected to the belt 100 through the connecting pipe 300. Next, the belt 100 is wrapped around the target compressed site on the arm or the leg of the user.

How the belt 100 is securely placed on the target compressed site is as follows.

[When User places Belt on His or Her Own Leg]

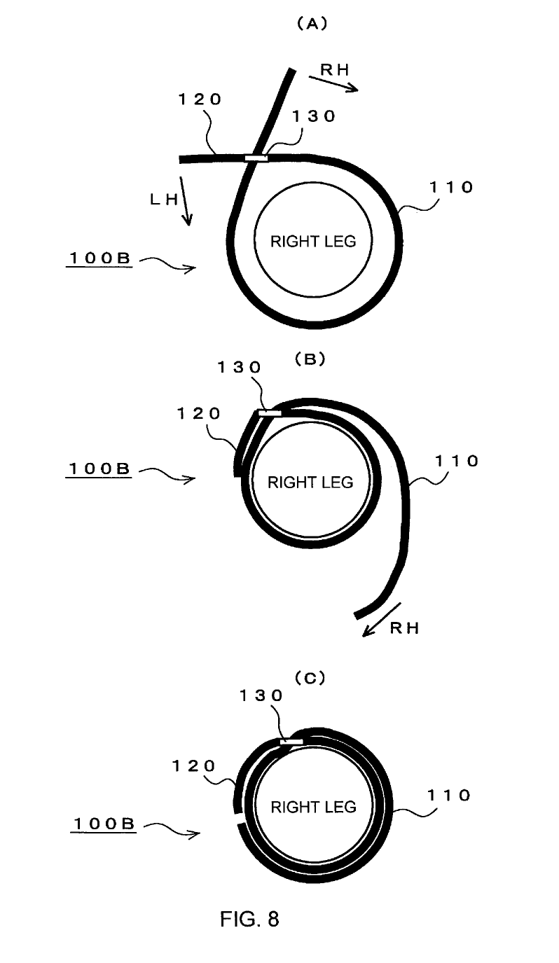

The belt 100B for legs is placed on the user's own leg in a manner as shown in FIG. 8. FIGS. 8(A) to 8(C) illustrate a procedure to place the belt 100B on the target compressed site on the right leg. A cross-section of the right thigh is seen from the above, and the upper side with respect to the paper surface corresponds to the user's front thigh.

In order to place the belt 100B for legs on the user's own leg, the distal end of the first band-shaped member 110 of the belt 100B is inserted into the opening in the joint member 130 to form a loop of the first band-shaped member 110, and then the right leg is passed through the loop as shown in FIG. 8(A). For this purpose, it is easier to take steps of forming a loop as described above, inserting the right foot into it, and then moving up the belt 100B towards the proximal portion of the leg.

In this state, the distal end of the first band-shaped member 110 is held with the right hand and is pulled in the direction depicted by the arrow RH. The distal end of the second band-shaped member 120 is held with the left hand and is pulled in the direction depicted by the arrow LH. This reduces the size of the aforementioned loop of the first band-shaped member 110, applying an appropriate tension to the belt 100B.

Then, the user further pulls the second band-shaped member 120 with his or her left hand. The third hook-and-loop fastener 123 on the inner surface of the second band-shaped member 120 at the end thereof is engaged with the thick fabric 111 of the outer surface of the first band-shaped member 110, as shown in FIG. 8(B).

Next, the user further pulls the first band-shaped member 110 with his or her right hand in the direction depicted by the arrow RW in FIG. 8(B). Then, the second hook-and-loop fastener 113 on the inner surface of the first band-shaped member 110 at the end thereof is engaged with the thick fabric 111 of the outer surface of the first band-shaped member 110, as shown in FIG. 8(C). If the user has a slim leg or the belt 100B is stretched more than as usual because higher tension is applied to the belt 100B, the distal end of the first band-shaped member 110 may be overlapped with the distal end of the second band-shaped member 120. In such a case, the second hook-and-loop fastener 113 on the inner surface of the first band-shaped member 110 at the end thereof may be engaged with the thick fabric 121 of the outer surface of the second band-shaped member 120.

In this way, the user can securely place the belt 100B on his or her right leg.

Tightening the belt 100B on his or her left leg can be achieved by using the same procedures as shown in FIG. 8 although all relationships reverse, as in a mirror image with respect to FIG. 8.

[When Someone places Belt on User's Arm or Leg]

For this purpose, the same procedures are used as those described in conjunction with the case where the user places the belt 100B on his or her own leg to let a third person place the belt 100A or the belt 100B on the user's arm or leg, respectively.

### [When User Places Belt on His or Her Own Arm]

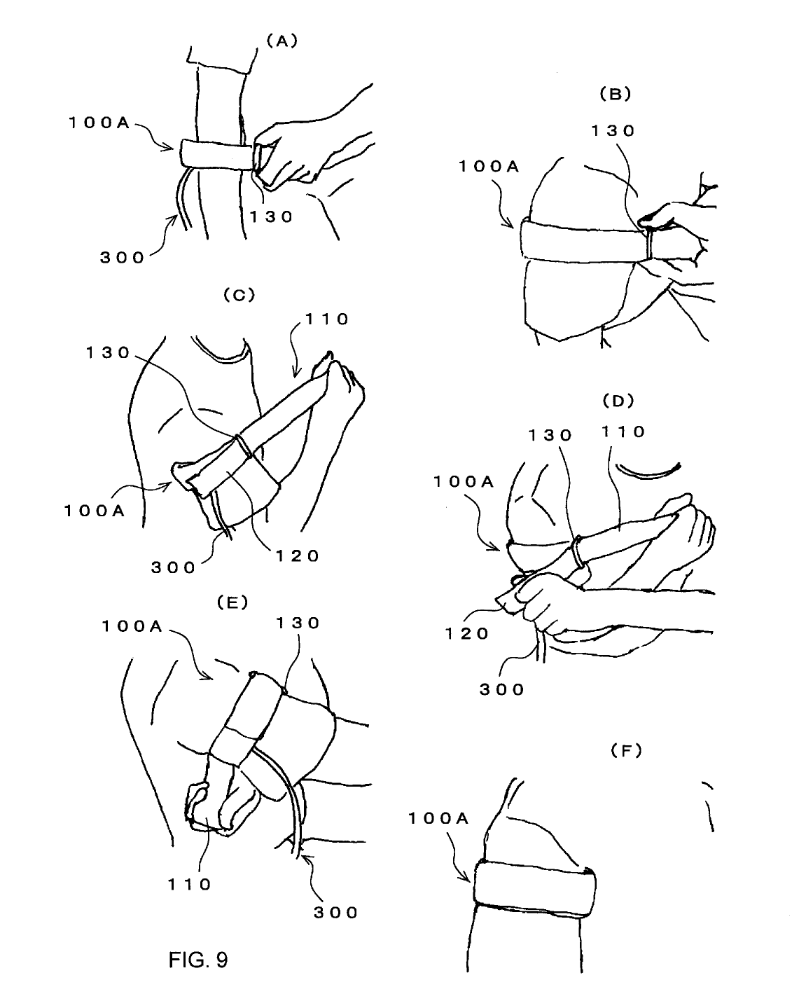

For this purpose, the belt is going to be placed through slightly different procedures from those described above. This is described with reference to FIG. 9.

In order to place the belt 100A on his or her own arm, the distal end of the first band-shaped member 110 of the belt 100A is inserted into the opening in the joint member 130 to form a loop of the first band-shaped member 110 as shown in FIG. 2.

Then, either arm is passed through the loop (FIG. 9(A)) and moves up the belt 100A with the hand of the other arm towards the proximal portion of the arm (FIG. 9(B)). In this case, care should be taken so that the first band-shaped member 110 is positioned on the armpit side and the second band-shaped member 120 is positioned on the opposite side.

In this state, the user holds the distal end of the first band-shaped member 110 with the hand of the arm passing through the loop of the first band-shaped member 110 (FIG. 9(C)). The arm on the same side as the hand holding the distal end of the first band-shaped member 110 is bent at the elbow towards the shoulder.

The user then holds the second band-shaped member 120 with the hand on the side opposite to the arm passing through the loop of the first band-shaped member 110, and pulls the second band-shaped member 120 outer downwards with respect to the arm passing through the loop (FIG. 9(D)). As described above, the first band-shaped member 110 is held with the hand on the same side as the arm passing through the loop, so that the belt 110A does not rotate around the target compressed site on the arm. In this state, by using the process similar to the one illustrated in FIG. 8(B), the third hook-and-loop fastener 123 on the inner surface of the second band-shaped member 120 at the end thereof is engaged with the thick fabric 111 of the outer surface of the first band-shaped member 110.

Next, the hand holding the distal end of the first band-shaped member 110 on the same side as the arm passing through the loop is released therefrom, and the distal end of the first band-shaped member 110 is held with the opposite hand. The distal end of the first band-shaped member 110 is pulled under the arm passing through the loop, in the direction away from the body to apply a desired tension to the first band-shaped member 110 (FIG. 9(E)). Then, the second hook-and-loop fastener 113 on the inner surface of the first band-shaped member 110 at the end thereof is engaged with the thick fabric 111 of the outer surface of the first band-shaped member 110, as shown in FIG. 8(C). In this case, if necessary, the second hook-and-loop fastener 113 on the first band-shaped member 110 may be engaged with the thick fabric 121 on the outer surface of the second band-shaped member 120, as in the case described above.

In this way, the user can place the belt 100A on his or her own arm (FIG. 9(F)).

Then, the main device 200 is switched to the training mode to perform the KAATSU muscle training. In order to direct the main device 200 to carry out the training mode, the input device can appropriately be manipulated as described above.

When the training mode begins, the user who receives the KAATSU muscle training manipulates the input device to select a set of four control data intended to be used for him or her. If there are two or more sets of the control data, then an appropriate set of the control data is selected in view of, for example, his or her physical conditions. The user can select the control data by using the input device. When the information indicating which set of the control data is selected is supplied from the input device, this information is transmitted to the control unit 415 through the interface 404 and the received information analyzing unit 411. The control unit 415 reads the control data indicated by this information out of the control data recording unit 413 and transmits them to the output control unit 414. The output control unit 414 controls the pumps 210 according to the control data. The pump 210 automatically keeps the air pressure within the pump 210 to a level indicated by the control data while measuring the air pressure within the pump 210 by using the pressure gauge, and in turn, keeps the air pressure within the inflatable pneumatic bag 114 to an appropriate level.

With the increase of the air pressure within the inflatable pneumatic bag 114, the inflatable pneumatic bag 114 expands. The outward expansion of the inflatable pneumatic bag 114 is confined by the small pieces 115 and the strips of tape 116. The lateral expansion of the inflatable pneumatic bag 114 is confined by the first band-shaped member 110 that is confined by the strips of tape 116 to expand in the lateral direction. Thus, the inflatable pneumatic bag 114 will expand only in the inward direction.

The magnitude of the air pressure within the inflatable pneumatic bag 114 and how long a given air pressure is continued depend on the age, gender, exercise history, physical condition, and the like, which are controlled appropriately by the aforementioned control data. The blood flow into the limb distal to the target compressed site of the compressed arm or leg of the user is restricted, which artificially produce exercising arms or legs. The arms and legs, in this embodiment, are not compressed simultaneously.

The KAATSU muscle training is performed in the manner described above. During the time when the target compressed site is applied with the compression force by the belt 100, the user may be placed at rest or may perform exercises though light.

When the user performs exercises, it may be better that the connecting pipe 300 can be separated into two parts. In such a case, the part of the connecting pipe on the belt 100 may have a mechanism such as a valve to prevent the air within the inflatable pneumatic bag 114 from being escaped.

After the KAATSU muscle training, the user removes the belt.

### <<Modified Version>>

A belt according to the modified version is generally identical to the belt in the first embodiment.

In the belt in the first embodiment, the strips of tape 116, the thick fabric 111, and the thin fabric 112 are stitched together.

In the belt according to the modified version, the strips of tape 116, the thick fabric 111, and the thin fabric 112 are bonded together. For example, they may be bonded over all surfaces closer to the edges of the first band-shaped member 110 across the dotted line S in FIG. 4.

In addition, the strips of tape 116, the thick fabric 111, and the thin fabric 112 may be attached to each other by using fusion or welding instead of the bonding. In such a case, for example, each of the strips of tape 116, the thick fabric 111, and the thin fabric 112 may be formed of a thermoplastic resin. The range of fusion or welding in this case may be similar to the one that is described in conjunction with the bonding.

### Second Embodiment

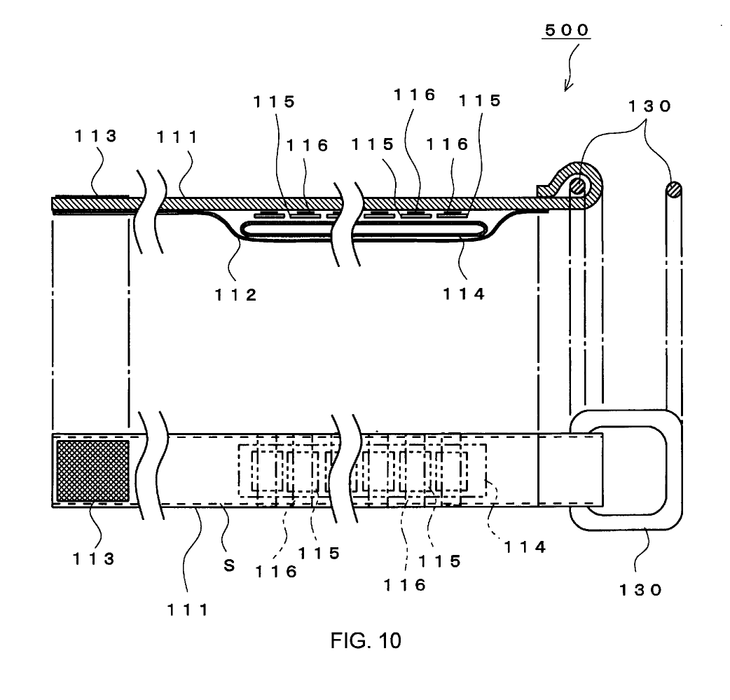

A belt 500 for the KAATSU muscle training in a second embodiment is shown in FIG. 10. The upper and lower parts of FIG. 10 show a longitudinal cross-sectional view of a belt 500 and a plane perspective view of the belt, respectively.

In short, the belt 500 in the second embodiment is equivalent to the belt 100 in the first embodiment except that there is no second band-shaped member 120.

The belt 500 comprises, as in the case of the first band-shaped member 110 in the first embodiment, a thick fabric 111, a thin fabric 112, a second hook-and-loop fastener 113, an inflatable pneumatic bag 114, small pieces 115, strips of tape 116, and a joint member 130. These components in the belt 500 are basically identical to those included in the first band-shaped member 110 in the first embodiment.

A difference lies in the lengths of the thick fabric 111 and the thin fabric 112 that form the belt 500. The lengths of the thick fabric 111 and the thin fabric 112 are each equal to the length of the belt 500. It is required that the length of the belt 500 is longer than the length that is enough to be wound around the target compressed site one complete turn. Typically, it may be the length that is approximately two times the circumference of the target compressed site. The lengths of the thick fabric 111 and the thin fabric 112 are determined depending on the length of the belt 500 which falls within the aforementioned range. In this embodiment, the lengths of the belt 500, the thick fabric 111 and the thin fabric 112 are each 30% longer than the length of the girth of the target compressed site.

Unlike the first embodiment, the second hook-and-loop fastener 113 of the belt 500 is provided at the end of the thick fabric 111.

The belt 500 in the second embodiment is used in combination with a main device and a connecting pipe which are similar to those described in conjunction with the first embodiment, to form a KAATSU muscle training apparatus. How to use the KAATSU muscle training apparatus including the belt 500 in the second embodiment is basically identical to the way how the KAATSU muscle training apparatus in the first embodiment is used.

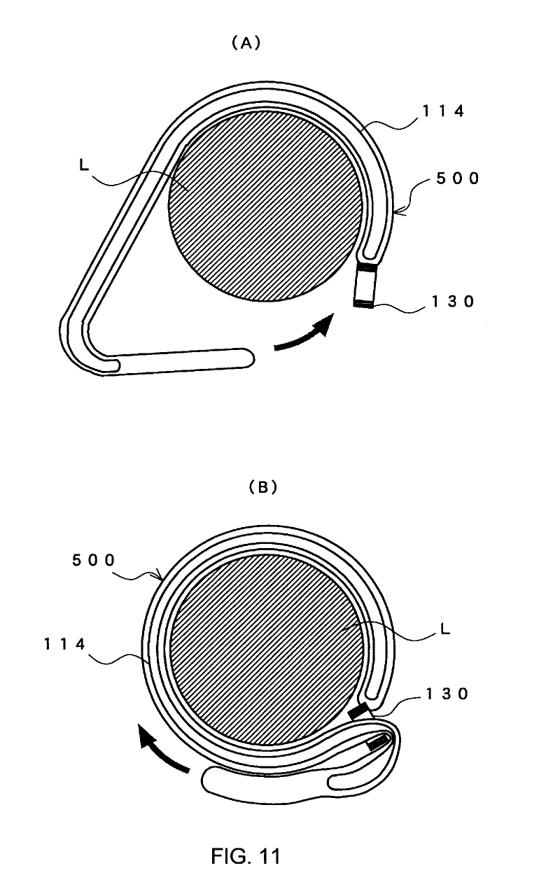

Among procedures to use the belt 500 in the second embodiment, how the belt 500 is placed on the target compressed site differs from the one for the belt in the first embodiment. The way of placing is described with reference to FIG. 11.

This belt 500 is wrapped around a target compressed site near the proximal portion of an arm or leg of a person who receives the KAATSU muscle training, as shown in FIGS. 11(A) and 11(B). The symbol “L” in FIGS. 11(A) and 11(B) represents a cross section of the arm of the person who receives the KAATSU muscle training. It should be noted that the belt 500 is simplified in structure in FIG. 11.

As shown in FIG. 11(A), in order to wrap the belt 500 on the arm, one end (where the joint member 130 is provided) is held on a predetermined portion of the arm and the belt 500 is wound around the arm “L”.

Then, as shown in FIG. 11(B), the other end of the belt 500 is passed through the joint member 130 and is folded back. Furthermore, the other end of the belt 500 is pulled in the direction depicted by the arrow in FIG. 11(B). With the belt applied with predetermined tension and wrapped around the arm, the second hook-and-loop fastener 113 that is provided at the end of the belt 500 is engaged with an appropriate portion on the thick fabric 111. This completes the secure placement of the belt 500 on the arm.

1. A belt for muscle training for the development of muscles that is used for applying a predetermined force for pressurization to a target compressed site near the proximal portion of one of the limbs of a user so that blood flow through the limb is restricted, the belt comprising:
a stretchable band-shaped member, at least a part of the band-shaped member having a tube-like shape, the band-shaped member having a length that is enough to be wound around the target compressed site almost one complete turn or more;
fastening means with which the shape of said band-shaped member can be maintained while said band-shaped member is wrapped around the target compressed site;
an inflatable pneumatic bag that is disposed within the tube-like portion of said band-shaped member, the inflatable pneumatic bag having a length that is enough to be wound around the target compressed site almost one complete turn or more, the inflatable pneumatic bag being air tight and being adapted to supply gas from the outside to the inside thereof and to remove the gas within it from the outside;
a plurality of plate-shaped small pieces that are aligned along the radially outward extremity of said inflatable pneumatic bag; and
strips of tape each having a predetermined width, the strip of tape being fixed to the outer surface of said small piece at the midpoint along the longitudinal center line thereof that is in parallel with the direction of the width of said band-shaped member, the opposite ends of each strip of tape being fixed to the opposite edges of said band-shaped member, the opposite edges corresponding to the opposite ends thereof in a lateral direction, the strip of tape being made of an unstretchable material.

2. The belt for muscle training as claimed in claim 1, wherein said small pieces are positioned so that the adjacent small pieces are spaced apart from each other by 10 mm or less during the time when said belt is not tensioned.

3. The belt for muscle training as claimed in claim 1, wherein the width of the ends of said strip of tape that are fixed to said both edges of said band-shaped member is shorter than the length of said small piece in the longitudinal direction of said band-shaped member.

4. The belt for muscle training as claimed in claim 1, wherein said small piece has a rectangular shape and one of two pairs of opposite sides of said small piece is in parallel with the lengthwise direction of said belt.

5. The belt for muscle training as claimed in claim 1, wherein said tube-like portion of said band-shaped member comprises a piece of elongated outer fabric that is provided outside and a piece of elongated inner surface that is provided inside, the opposite edges corresponding to the opposite ends of the outer fabric and the inner fabric in a widthwise direction being connected to each other,
said strip of tape being fixed to said band-shaped member at the opposite ends thereof with the opposite ends being sandwiched between said opposite edges of said outer fabric and the inner fabric.

6. The belt for muscle training as claimed in claim 5, wherein said tube-like portion of said band-shaped member comprises a piece of elongated outer fabric that is provided outside and a piece of elongated inner surface that is provided inside, the opposite edges corresponding to the opposite ends of the outer fabric and the inner fabric in a widthwise direction being stitched to each other,
said strip of tape being fixed to said band-shaped member at the ends thereof with the ends being stitched together with said both edges of said outer fabric and the inner fabric.

7. The belt for muscle training as claimed in claim 1, wherein said inflatable pneumatic bag is stretchable in the longitudinal direction thereof.

8. A muscle training apparatus comprising:
at least one belt for muscle training for the development of muscles that is used for applying a predetermined force for pressurization to a target compressed site near the proximal portion of at least one of the limbs of a user so that blood flow through the limb is restricted; and
a main device having a pump, the main device being used in combination with said belt,
said belt comprising:
a stretchable band-shaped member, at least a part of the band-shaped member having a tube-like shape, the band-shaped member having a length that is enough to be wound around the target compressed site almost one complete turn or more;
fastening means with which the shape of said band-shaped member can be maintained while said band-shaped member is wrapped around the target compressed site;
an inflatable pneumatic bag that is disposed within the tube-like portion of said band-shaped member, the inflatable pneumatic bag having a length that is enough to be wound around the target compressed site almost one complete turn or more, the inflatable pneumatic bag being air tight and being adapted to supply gas from the outside to the inside thereof and to remove the gas within it from the outside;
a plurality of plate-shaped small pieces that are aligned along the radially outward extremity of said inflatable pneumatic bag; and
strips of tape each having a predetermined width, the strip of tape being fixed to the outer surface of said small piece at the midpoint along the longitudinal center line thereof that is in parallel with the direction of the width of said band-shaped member, the opposite ends of each strip of tape being fixed to the opposite edges of said band-shaped member, the opposite edges corresponding to the opposite ends thereof in a lateral direction, the strip of tape being made of an unstretchable material,
said main device being adapted to supply air into said inflatable pneumatic bag or to remove air from said inflatable pneumatic bag by using the pump that it has.
